(19) United States
(12) Patent Application Publication
(10) Pub. No.: US 2026/0154216 A1
(43) Pub. Date: Jun. 4, 2026

(54) DATA PROCESSING DEVICE AND DATA PROCESSING METHOD

(71) Applicant: Industrial Technology Research Institute, Hsinchu (TW)

(72) Inventors: Hsien-Ching Hsieh, Hsinchu County (TW); Po-Han Huang, Hsinchu County (TW); Chih-Wei Hsu, Hsinchu City (TW); Yung-Chao Chen, Hsinchu County (TW)

(73) Assignee: Industrial Technology Research Institute, Hsinchu (TW)

(21) Appl. No.: 19/001,358

(22) Filed: Dec. 24, 2024

(30) Foreign Application Priority Data
Dec. 2, 2024 (TW) 113146610

(51) Int. Cl. G06F 13/28; G06F 15/173

(52) U.S. Cl. CPC G06F 13/28; G06F 15/173

(57) ABSTRACT

A data processing device includes main memory, multiple processing elements, a direct memory access (DMA) controller, and a multicast controller. The main memory is configured to store data, in which the data includes unicast data or multicast data. The processing elements are configured to process the data. The DMA controller is configured to obtain the data from the main memory, provide the unicast data to one unicast processing element of the processing elements, and provide the multicast data to a multicast controller. The multicast controller is configured to obtain the multicast data from the DMA controller, and simultaneously provide the multicast data to multiple multicast processing elements of the processing elements.

### CROSS-REFERENCE TO RELATED APPLICATION

This application claims the priority benefit of Taiwan application serial no. 113146610, filed on Dec. 2, 2024. The entirety of the above-mentioned patent application is hereby incorporated by reference herein and made a part of this specification.

### TECHNICAL FIELD

The disclosure relates to a data processing device, and the technical field relates to a data processing device and a data processing method.

### BACKGROUND

Artificial Intelligence (AI) technology plays an increasingly important role in today's society. By collecting massive data and in combination with the learning capability of artificial intelligence, AI may assist people in various daily tasks or to more accurately predict future trends and optimize decision-making. Behind this, data computing provides AI with the basis for learning and analysis, thereby enabling the conversion of massive data into effective resources.

### SUMMARY

The disclosure provides a data processing device and a data processing method to effectively improve overall computing efficiency and reduce the energy consumption required for data movement.

The data processing device of the disclosure includes main memory, multiple processing elements, a direct memory access (DMA) controller, and a multicast controller. The main memory is configured to store data, in which the data includes unicast data or multicast data. The processing elements are configured to process the data. The DMA controller is configured to obtain the data from the main memory, provide the unicast data to one unicast processing element of the processing elements, and provide the multicast data to a multicast controller. The multicast controller is configured to obtain the multicast data from the DMA controller, and simultaneously provide the multicast data to multiple multicast processing elements of the processing elements.

The data processing method of the disclosure includes: data is obtained from main memory via a direct memory access (DMA) controller, in which the data includes unicast data or multicast data; the unicast data is provided to one unicast processing element of multiple processing elements via the DMA controller; the multicast data is obtained from the DMA controller via a multicast controller; and the multicast data is simultaneously provided to multiple multicast processing elements of the processing elements via the multicast controller.

Based on the above, by adding a multicast controller to the processor architecture, the limitation of conventional architectures that merely support one-to-one single-point transmission may be improved, thereby achieving one-to-many transmission.

To make the foregoing more easily understood, multiple embodiments are described in detail below in conjunction with the drawings.

The inventive concept may be embodied in various forms without being limited to the exemplary embodiments set forth herein. Descriptions of well-known parts are omitted for clarity, and like reference numerals refer to like elements throughout.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 is a schematic diagram of a data processing device according to an embodiment of the disclosure.

FIG. 2 is a schematic diagram of a data processing device according to an embodiment of the disclosure.

FIG. 3 is a schematic diagram of a processing element (PE) according to an embodiment of the disclosure.

FIG. 4A is a schematic diagram of a multicast mechanism according to an embodiment of the disclosure.

FIG. 4B is a schematic diagram of a protocol translator according to an embodiment of the disclosure.

FIG. 4C is a schematic diagram of an activate switching device according to an embodiment of the disclosure.

FIG. 5 is a schematic diagram of a data processing device according to an embodiment of the disclosure.

FIG. 6 is a schematic flowchart of a data processing method according to an embodiment of the disclosure.

### DETAILED DESCRIPTION OF DISCLOSURED EMBODIMENTS

The following description will refer to the embodiments of the disclosure shown in the accompanying drawings to assist readers in fully understanding the methods, devices and/or systems described herein. Therefore, those skilled in the art may suggest various changes, modifications or equivalent substitutions to the systems, devices and/or methods described herein. In addition, for the sake of clarity and conciseness, descriptions of known functions and structures may be omitted. Furthermore, where possible, the same reference numerals are used in the drawings and descriptions to refer to the same or similar parts.

Artificial Intelligence (AI) technology plays an increasingly important role in today's society. By collecting massive data and in combination with the learning capability of artificial intelligence, AI may assist people in various daily tasks or to more accurately predict future trends and optimize decision-making. Behind this, data computing provides AI with the basis for learning and analysis, thereby enabling the conversion of massive data into effective resources.

For example, the application of Large Language Models (LLMs) in daily life is actually closely related to us. Even without directly conversing with various artificial intelligence service platforms (such as ChatGPT), many AI applications in daily life are based on large language models, including realizing realistic interactive conversations for customer service, conducting more intelligent network searches, and rapidly analyzing large-scale databases, further enhancing AI's understanding and response capability to user needs. For training the large language models with billions of parameters and requiring sufficient memory, how to efficiently disseminate computing data indeed poses a significant technical challenge.

In recent years, Convolutional Neural Networks (CNNs) maintain high accuracy through high-complexity calculations. However, convolutional operations generate massive amounts of calculations during the process, resulting in massive data movement in memory and consuming a large amount of energy.

For example, in an AI processor architecture, it is typically composed of a host CPU, main memory, a direct memory access (DMA) controller, a bus, and multiple processing elements (PEs). Moreover, within each of the PEs, there also exists share memory (or referred to as local memory). The function of the share memory is to temporarily store the data and results calculated by the PE. If certain data and results are continuously used subsequently, the data is temporarily stored in the share memory. Additionally, the main memory is usually composed of dynamic random-access memory (DRAM), while the share memory is usually composed of static random-access memory (SRAM).

It should be noted that, in terms of existing AI processor architectures and technologies, unless there are special specifications for processing elements and memory interfaces, all hardware needs to rely on the bus for serial connection, and all hardware needs to comply with the protocol established by the bus. Moreover, when the same data needs to be used by multiple PEs, the DMA controller is typically used to move the data. For example, when the same data needs to be transmitted to four PEs, the DMA controller repeatedly obtains the same data from the main memory and write the same data respectively into the share memory of the four PEs. That is, although the four PEs require the same data, due to the existing architecture merely supporting one-to-one single-point transmission, the transmission of the same data needs to be repeated four times to complete. In other words, repetitive data movement causes massive energy consumption and reduces computing efficiency. This is a time-consuming and labor-intensive issue that needs to be addressed for highly parallelized computing architectures. Therefore, how to effectively improve overall computing efficiency and reduce the energy consumption required for data movement is the goal pursued by those skilled in the art.

It is worth noting that, in order to improve overall computing efficiency and reduce the energy consumption required for data movement, the order of data reading is a key factor. Therefore, the disclosure proposes a solution for reducing data transmission and increasing reuse rate within limited hardware resources. Specifically, to achieve smooth and parallel data exchange between any memory or internal memory of any processor, the disclosure proposes a multicast mechanism for data sharing in a multi-core architecture. By adding a multicast mechanism to the existing AI processor architecture, the limitation of the bus architecture that merely supports one-to-one single-point transmission may be improved, thereby achieving one-to-many transmission. As such, the architecture proposed in the disclosure may achieve low-latency communication between memory and multi-core clusters, thereby improving overall computing efficiency and reducing the energy consumption required for data movement.

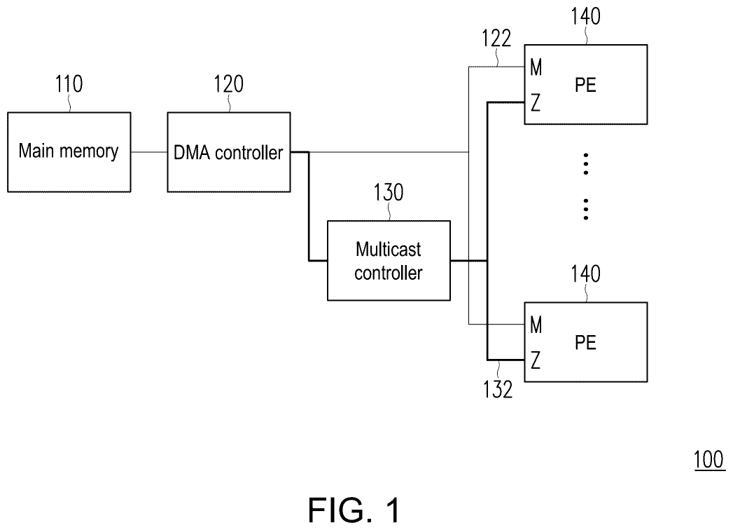

FIG. 1 is a schematic diagram of a data processing device according to an embodiment of the disclosure. Referring to FIG. 1, a data processing device 100 may include main memory 110, a direct memory access (DMA) controller 120, a multicast controller 130, and multiple processing elements (PEs) 140.

In an embodiment, the main memory 110 may be configured to store data, which may include unicast data or multicast data. Additionally, the PEs 140 may be configured to process data. Furthermore, the DMA controller 120 may be configured to obtain data from the main memory 110, provide unicast data to one unicast PE (i.e., the PE 140 receiving unicast data) of the PEs 140, and provide multicast data to the multicast controller 130. Moreover, the multicast controller 130 may be configured to obtain multicast data from the DMA controller 120, and simultaneously provide the multicast data to multiple multicast PEs (i.e., the PEs 140 receiving multicast data) of the PEs 140.

In addition, data transmission between the main memory 110, the DMA controller 120, and the PEs 140 may be conducted via a bus 122. Specifically, the bus 122 may be configured to transmit unicast data. Furthermore, the DMA controller 120 may be configured to provide unicast data to one unicast PE of the PEs 140 via the bus 122. Moreover, the bus 122 may be coupled between the DMA controller 120, the PEs 140, and the main memory 110. In other words, for one-to-one data transmission (i.e., transmitting unicast data), the bus 122 may provide a path for data transmission.

On the other hand, data transmission between the multicast controller 130, the DMA controller 120, and the PEs 140 may be conducted via a multicast channel 132. Specifically, the multicast channel 132 may be configured to transmit multicast data. Furthermore, the multicast controller 130 may be configured to simultaneously provide multicast data to multiple multicast PEs of the PEs 140 via the multicast channel 132. Moreover, the multicast channel 132 is coupled between the multicast controller 130 and the PEs 140. In other words, for one-to-many data transmission (i.e., transmitting multicast data or broadcast data), the multicast channel 132 may provide a path for data transmission.

It should be noted that, for the sake of simplicity, the bus 122 or the multicast channel 132 is not fully illustrated in FIG. 1. For example, the bus 122 may be directly coupled to the DMA controller 120, the PEs 140, and the main memory 110, rather than indirectly coupled to the main memory 110 as shown in the figure. Additionally, the multicast channel 132 may be directly coupled to the DMA controller 120, rather than indirectly coupled to the DMA controller 120 as shown in the figure. However, the disclosure is not limited thereto.

It is further noted that the PE 140 may include one or more ports. In other words, the PE 140 may be single-port, dual-port, or multiple-port. To put it another way, the ports of the PE 140 may include a master port M and/or at least one slave port (not shown in the figure). Moreover, the master port and/or slave port of the PE 140 may be respectively coupled to the bus 122, for receiving signals from the bus 122 or providing signals to the bus 122.

On the other hand, in addition to the original ports (for example, the master port of a single port or the master port and slave port of a dual port), the PE 140 may further include a multicast port Z, and the multicast port Z may be coupled to the multicast controller 130 for receiving signals from the multicast controller 130 or providing signals to the multicast controller 130. In an embodiment, the multicast port Z may be an additional port attached to the PE 140, thus becoming an additional multicast port Z or an additional slave port. In another embodiment, the multicast port Z may directly modify an idle port of the PE 140 itself (for example, a certain slave port), thus becoming a port specifically used for transmission by the multicast controller 130. However, the disclosure is not limited thereto.

Based on the above, by adding the multicast controller 130 and the multicast channel 132 as a multicast mechanism in the AI processor architecture, the limitation of the bus architecture supporting merely one-to-one single-point transmission may be improved, thereby achieving one-to-many transmission. For example, in AI operations, the same weight data usually needs to be provided simultaneously to multiple PEs 140 to perform calculations of convolutional neural networks. Compared to repeatedly fetching data from the main memory 110 and transmitting the data respectively to multiple PEs 140, multicasting data at once may save massive time and reduce energy consumption. In this way, the data processing device 100 may achieve low-latency communication between the memory and the multi-core clusters, thereby improving overall computing efficiency and reducing the energy consumption required for data movement.

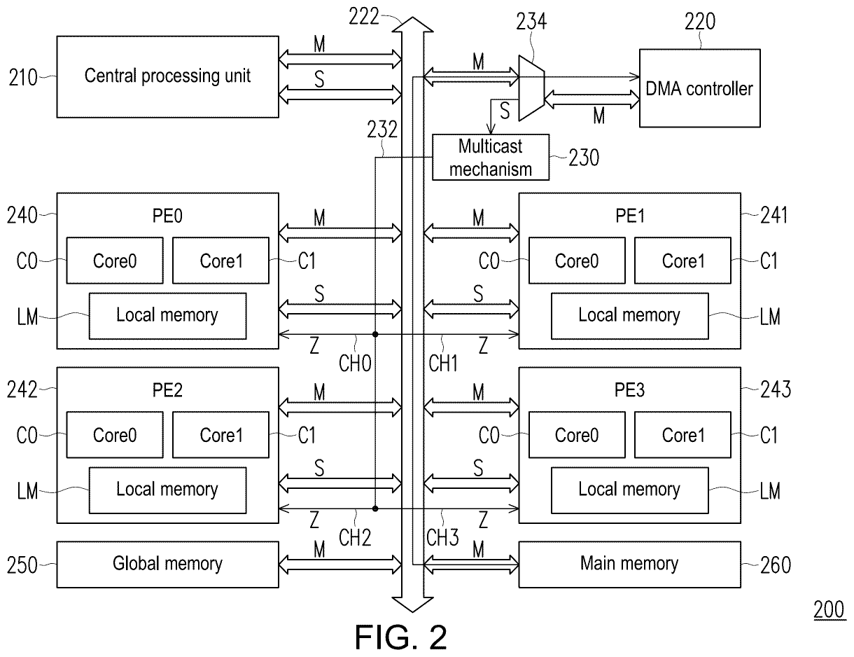

FIG. 2 is a schematic diagram of a data processing device according to an embodiment of the disclosure. Referring to FIG. 1 and FIG. 2, a data processing device 200 in FIG. 2 is an implementation of the data processing device 100 in FIG. 1. However, the disclosure is not limited thereto.

In an embodiment, the data processing device 200 may include a central processing unit 210, a direct memory access (DMA) controller 220, a multicast mechanism 230, a mode multiplexer 234, multiple processing elements (PEs) 240˜243, global memory 250, and main memory 260. Moreover, each of the PEs 240˜243 may include dual cores C0˜C1 and local memory LM. Additionally, the central processing unit 210, the DMA controller 220, the multicast mechanism 230, the mode multiplexer 234, the PEs 240˜243, the global memory 250, and the main memory 260 may each include a master port M, a slave port S, and/or a multicast port Z. It should be noted that for the convenience of distinction, the PEs 240˜243 may be referred to as PE0, PE1, PE2, and PE3 respectively, and the dual cores C0˜C1 may be referred to as Core0 and Core1 respectively.

In addition, the bus 222 may be coupled between the central processing unit 210, the DMA controller 220, the PEs 240˜243, the global memory 250, and the main memory 260. On the other hand, the multicast channel 232 may be coupled between the multicast mechanism 230 and the PEs 240˜243. Moreover, the multicast channel 232 may include transmission channels CH0˜CH3, respectively coupled to the PEs 240˜243.

In an embodiment, the DMA controller 220, the multicast mechanism 230, the PEs 240˜243, and the main memory 260 in FIG. 2 may correspond respectively to the DMA controller 120, the multicast controller 130, the PEs 140, and the main memory 110 in FIG. 1. However, the disclosure is not limited thereto.

In an embodiment, the mode multiplexer 234 may be coupled between the DMA controller 220 and the multicast mechanism 230. Moreover, the mode multiplexer 234 may be configured to, based on a mode signal, transmit data from the DMA controller 220 to one unicast PE (for example, one of PE0, PE1, PE2, and PE3) or multiple multicast PEs (for example, PE0, PE1, and PE2). That is, the mode multiplexer 234 may provide data to one unicast PE or multiple multicast PEs based on the current transmission mode (for example, unicast mode or multicast mode). In other words, when the mode signal indicates unicast mode, the mode multiplexer 234 may be configured to select the bus 222 (for example, activating the master port M of the mode multiplexer 234, and deactivating the slave port S of the mode multiplexer 234) as the transmission path for the data. On the other hand, when the mode signal indicates multicast mode, the mode multiplexer 234 may be configured to select the multicast channel 232 (for example, activating the slave port S of the mode multiplexer 234, and deactivating the master port M of the mode multiplexer 234) as the transmission path for the data. However, the disclosure is not limited thereto.

In an embodiment, the mode signal may be configured to be automatically determined by the central processing unit 210 and provided to the mode multiplexer 234 by the central processing unit 210. For example, the central processing unit 210 may automatically determine the data as unicast data or multicast data according to the number of transmission objects of the data, thereby determining the content of the mode signal. In other words, in response to the transmission object of the data being one of the PEs 240˜243, the central processing unit 210 may be configured to determine the data as unicast data and determine the content of the mode signal as unicast mode. On the other hand, in response to the transmission objects of the data being multiple of the PEs 240˜243, the central processing unit 210 may be configured to determine the data as multicast data and determine the content of the mode signal as multicast mode. However, the disclosure is not limited thereto.

In another embodiment, the mode signal may be configured to be determined by a user. That is, the user may determine the content of the mode signal as unicast mode or multicast mode based on actual requirements. Moreover, the user's intention may be received by various input devices and converted into a user command. In other words, the central processing unit 210 may be configured to: based on the User Command, determine the data as unicast data or multicast data, and determine the content of the mode signal as unicast mode or multicast mode.

It should be noted that when the data processing device 200 needs to perform one-to-one data transmission (i.e., unicast mode), the DMA controller 220 may obtain data (also referred to as unicast data) from the main memory 260 with larger capacity, and provide the data to one of the PEs 240˜243 (i.e., the unicast PE) via the bus 222. It is worth noting that when the transmitted data is commonly used data, the data may be stored in the global memory with faster speed for the DMA controller 220 to obtain the data quickly. In other words, the main memory 260 is usually large-capacity memory (for example, DRAM), while the global memory 250 is usually high-speed memory (for example, SRAM). However, the disclosure is not limited thereto.

On the other hand, when the data processing device 200 needs to perform one-to-many data transmission (i.e., multicast mode), the DMA controller 220 may obtain data (also referred to as multicast data) from the main memory 260 or the global memory 250, and provide the data to the multicast mechanism 230. The multicast mechanism 230 may simultaneously provide the data to at least two or all of the PEs 240˜243 (i.e., the multicast PEs) at once. It is worth noting that the multicast mechanism 230 may directly provide the data to the local memory LM of the PEs 240˜243, rather than merely providing the data to the PEs 240˜243. The detailed technical aspects will be further discussed below.

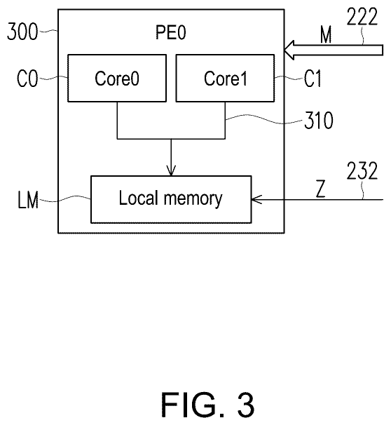

FIG. 3 is a schematic diagram of a processing element (PE) according to an embodiment of the disclosure. Referring to FIG. 1 to FIG. 3, a processing element (PE) 300 in FIG. 3 is an implementation of the PE 140 in FIG. 1 or the PEs 240˜243 in FIG. 2. However, the disclosure is not limited thereto.

In an embodiment, the PE 300 may include dual cores C0˜C1, local memory LM, interconnection 310, a master port M, and a multicast port Z. It is worth noting that according to design requirements, the PE 300 may be further subdivided into or include more components, such as: an Arithmetic Logic Unit (ALU), a Multiply-Accumulate (MAC) unit, a Neural Processing Unit (NPU), a Graphics Processing Unit (GPU) and/or a Tensor Processing Unit (TPU). However, the disclosure is not limited thereto.

When the master port M receives a signal via the bus 222, based on the destination address included in the signal, the signal is allocated through the interconnection to the corresponding component (also referred to as the destination component) of the PE 300 according to the destination address. That is, the destination address may be configured to indicate the destination component (for example, Core0, Core1, ALU or MAC unit) in the PE 300. Moreover, based on the destination address, the signal is converted into a protocol of the interface standard adopted by the destination component (for example, converted via the input/output interface), and transmitted to the destination component. In other words, after the signal is received by the master port M, the signal still needs to go through steps such as determining the destination address and converting the protocol before the signal is received by the destination component.

On the other hand, when the multicast port Z receives a signal via the multicast channel 232, since the multicast port Z is directly coupled to the local memory LM inside the PE 300 (rather than coupled to the input/output interface of the PE 300), the destination of the signal (i.e., multicast data) received by the multicast port Z is bound to be the local memory LM. Therefore, the signal received by the multicast port Z may be pre-converted into the protocol adopted by the local memory LM. In other words, after the signal is received by the multicast port Z, immediately afterwards, the local memory LM may receive the signal, thereby saving needless energy consumption and increasing processing efficiency.

In addition, similar to the global memory, the function of the local memory LM is to temporarily store the data and results calculated by the PE 300. If certain data and results are continuously used subsequently, the data is temporarily stored in the local memory LM. Therefore, the local memory LM is usually high-speed memory (for example, SRAM). However, the disclosure is not limited thereto.

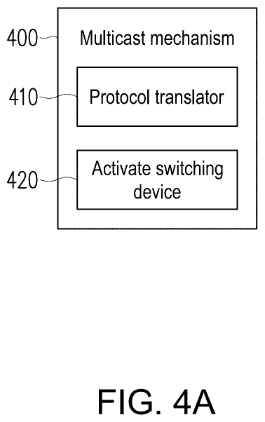

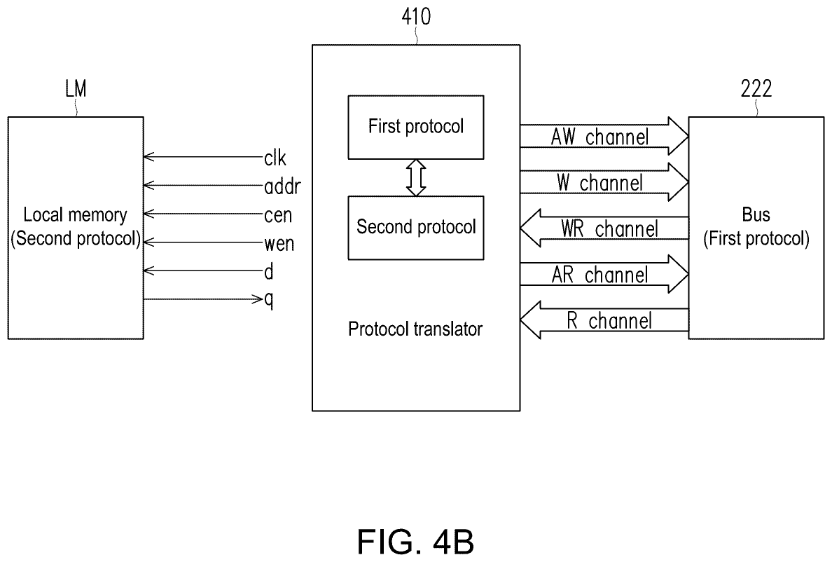

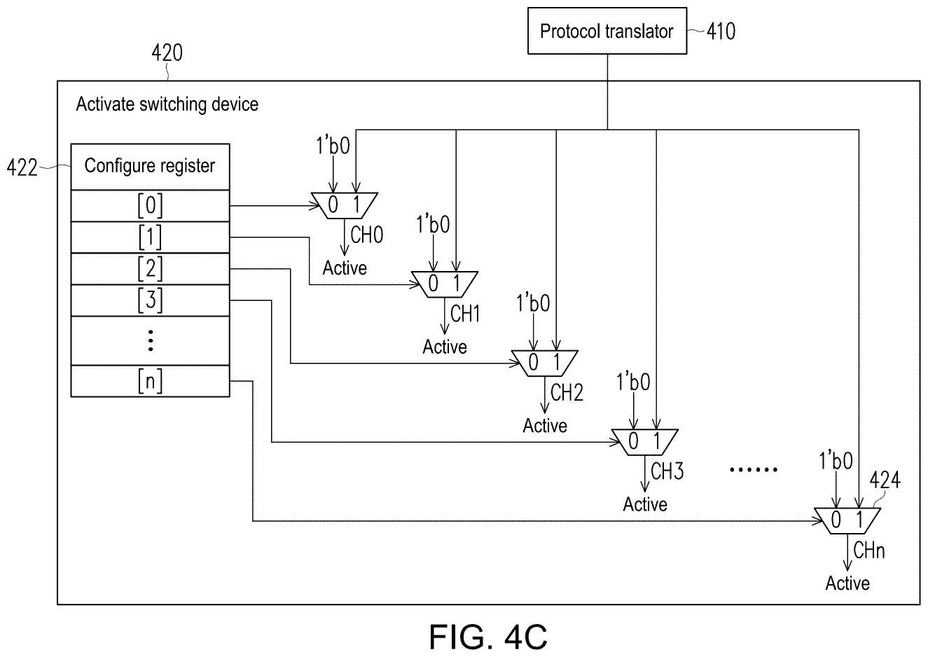

FIG. 4A is a schematic diagram of a multicast mechanism according to an embodiment of the disclosure. Referring to FIG. 1 to FIG. 4A, a multicast mechanism 400 in FIG. 4A is an implementation of the multicast controller 130 in FIG. 1 or the multicast mechanism 230 in FIG. 2. However, the disclosure is not limited thereto.

In an embodiment, the multicast mechanism 400 may include a protocol translator 410 and an activate switching device. As mentioned earlier, the multicast mechanism 400 may receive multicast data from the DMA controller 220 (for example, receiving multicast data via the mode multiplexer 234), and provide the multicast data to at least two or all of the PEs 240˜243 via the multicast channel 232. Moreover, as shown in FIG. 3, the multicast data is directly provided to the local memory LM via the multicast channel 232, and the multicast data may be pre-converted into the protocol adopted by the local memory LM.

It should be noted that the conversion of the protocol of the multicast data may be performed via the protocol translator 410. In other words, the protocol translator 410 may be configured to convert the multicast data from a first protocol to a second protocol. In this way, the conversion of the protocol of the multicast data may be executed in advance and uniformly by the protocol translator 410, thereby simplifying the action of interface standard conversion that each of the PEs 240˜243 needs to perform individually.

In addition, after the multicast data is converted to an appropriate protocol, the multicast data is distributed to the multicast PEs of the PEs 240˜243. Similar to how the mode signal is used to determine the transmission mode of the mode multiplexer 234, a configuration signal may be used to determine the objects of transmission for the multicast mechanism 400. In other words, an activate switching device 420 may be configured to determine at least two PEs from the PEs 240˜243 as multiple multicast PEs based on the configuration signal.

FIG. 4B is a schematic diagram of a protocol translator according to an embodiment of the disclosure. Referring to FIG. 4A and FIG. 4B, a protocol translator 410 in FIG. 4B is an implementation of the protocol translator 410 in FIG. 4A. However, the disclosure is not limited thereto.

In an embodiment, AW, W, WR, AR, and R on the right side of the protocol translator 410 may respectively represent channels for Address Write, Write, Write Response, Address Response, and Response, while clk, addr, cen, wen, d, and q on the left side of the protocol translator 410 may respectively represent Clock signal, Address signal, Chip Enable signal, Write Enable signal, Data In signal, and Data Out signal. However, the disclosure is not limited thereto.

In an embodiment, the protocol translator 410 may be configured to process the conversion and connection of protocols for different interfaces. As shown in FIG. 4B, the right side of the protocol translator 410 may be used to transmit and receive signals from the bus 222, and the left side of the protocol translator 410 may be used to transmit and receive signals from the local memory LM. It should be noted that, as shown in FIG. 2, the right side of the multicast mechanism 230 receives signals from the DMA controller 220. Conventionally, when the DMA controller 220 outputs signals, the object of output is the bus 222. In other words, the signals output by the DMA controller 220 are converted in advance to the protocol adopted by the bus 222. Therefore, for the sake of simplicity, the right side of FIG. 4B directly illustrates the bus 222 and does not illustrate the mode multiplexer 234.

It should be noted that the protocol translator 410 may be configured to execute the conversion of protocols on both sides of the protocol translator 410. Regardless of the protocols of the interfaces on both sides, conversion may be performed via the protocol translator 410. For example, the bus 222 may include an Advanced extensible Interface (AXI) or Advanced High-performance Bus (AHB) interface, and the protocol adopted by the bus 222 may be the AXI protocol or AHB protocol. On the other hand, the local memory LM may include an SRAM standard interface, and the protocol adopted by the local memory LM may be the SRAM protocol. However, the disclosure is not limited thereto. In other words, the protocol translator 410 may convert signals between the first protocol adopted by the bus 222 and the second protocol adopted by the local memory LM.

In addition, the protocol translator 410 may support different clock domains adopted by protocols on both sides. For example, the execution frequency of the AXI protocol of the bus 222 may be 3 GHZ, and the execution frequency of the SRAM protocol of the local memory LM may be 1 GHz. The protocol translator 410 may be configured to convert the frequency of signals to comply with the execution frequency of each of the protocols. As a result, the integration between components with different protocols is easier. Moreover, the local memory LM may directly receive multicast data converted to the second protocol via the multicast channel 232, thereby saving needless energy consumption and increasing processing efficiency.

FIG. 4C is a schematic diagram of an activate switching device according to an embodiment of the disclosure. Referring to FIG. 4A and FIG. 4C, an activate switching device 420 in FIG. 4C is an implementation of the activate switching device 420 in FIG. 4A. However, the disclosure is not limited thereto.

In an embodiment, the activate switching device 420 may include a configure register 422 and multiple transport multiplexers 424. The configure register 422 may be used to temporarily store a configuration signal, and the configuration signal may be used to determine the object of transmission of the multicast mechanism 400. Moreover, first input terminals of the transport multiplexers 424 may be coupled to the protocol translator 410 to receive multicast data converted to the second protocol. Furthermore, second input terminals of the transport multiplexers 424 may be configured to receive a binary number zero with a size of 1 bit. In addition, output terminals of the transport multiplexers 424 may be respectively coupled to transmission channels CH0˜CHn connected to the respective objects of transmission.

It should be noted that the transport multiplexers 424 may activate or deactivate the transmission channels CH0˜CHn connected to the respective objects of transmission in the multicast channel 232 based on the object of transmission in the configuration signal. For example, the configuration signal may include multiple bits, such as bit [0] to bit [n]. Bit [0] to bit [n] may respectively indicate whether the corresponding transmission channels CH0˜CHn are activated or deactivated. For instance, when the value of bit [0] is 1, the transmission channel CH0 may be activated. On the other hand, when the value of bit [n] is 0, the transmission channel CHn may be deactivated. However, the disclosure is not limited thereto.

In other words, the multiple transport multiplexers 424 may be configured to, based on the configuration signal, activate the transmission channels coupling the multicast mechanism 400 (e.g., the multicast controller 130) to multiple multicast PEs, and deactivate the transmission channels coupling the multicast mechanism 400 to other PEs. Moreover, the configure register 422 may be configured to receive and store the configuration signal from the central processing unit 210, and provide the configuration signal to the transport multiplexers 424.

Moreover, similar to the mode signal, the configuration signal may be automatically determined by the central processing unit 210 or determined by the user. For example, the central processing unit 210 may determine the configuration signal based on the queue length or busy status of each of the PEs 240˜243. Alternatively, the user may decide which objects (i.e., multicast PEs) to transmit the multicast data to after conversion by the protocol translator 410, by configuring the configure register 422.

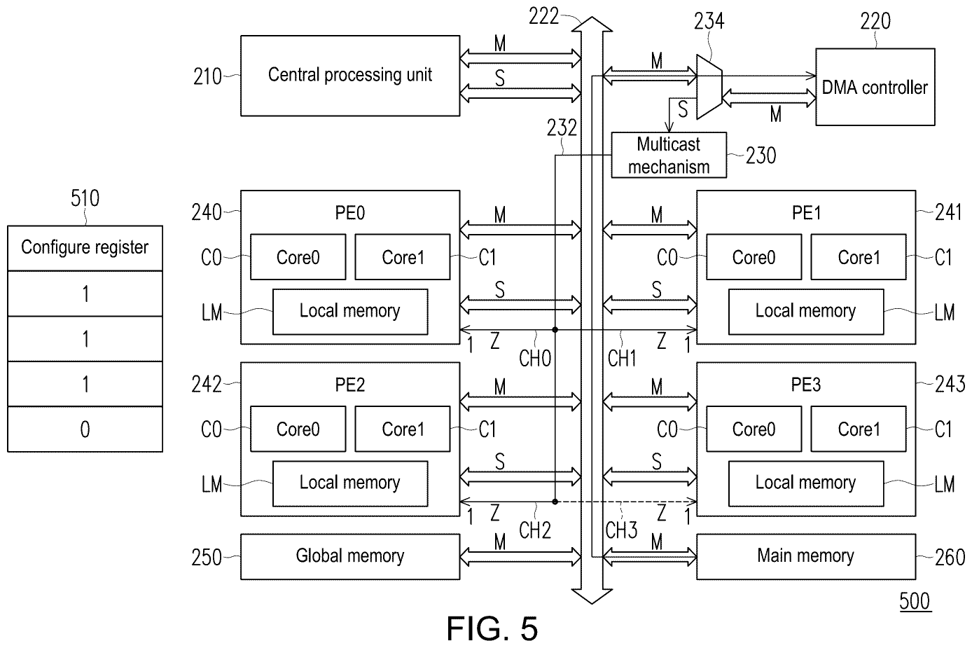

FIG. 5 is a schematic diagram of a data processing device according to an embodiment of the disclosure. Referring to FIG. 2, FIG. 4C and FIG. 5, the difference between a data processing device 500 in FIG. 5 and the data processing device 200 in FIG. 2 is that: a configure register 510 has already temporarily stored a configuration message. Additionally, for details about the data processing device 500 and the Configure Register 510, reference may be made to the descriptions of the data processing device 200 in FIG. 2 and the configure register 422 in FIG. 4C, and the description is not repeated here.

In an embodiment, a piece of identical data is to be moved to PE0, PE1, and PE2 through the DMA controller 220. In the disclosure, after the DMA controller 220 fetches the data from the main memory 260, instead of following the original path of the bus 222, the data goes through the multicast channel 232 coupled by the multicast mechanism 230. Specifically, the data first undergoes protocol conversion through the protocol translator 410. Next, by setting the configuration message of the configure register 510, the configure register is set to 0×1110 (1 represents activation, and 0 represents deactivation). In other words, the transmission channels CH0, CH1, and CH2 of the multicast channel 232 coupled to PE0, PE1, and PE2 are activated, and PE0, PE1, and PE2 receive the data transmitted from the DMA controller 220. On the other hand, the transmission channel CH3 of the multicast channel 232 coupled to PE3 is deactivated, and PE3 does not receive the data transmitted from the DMA controller 220.

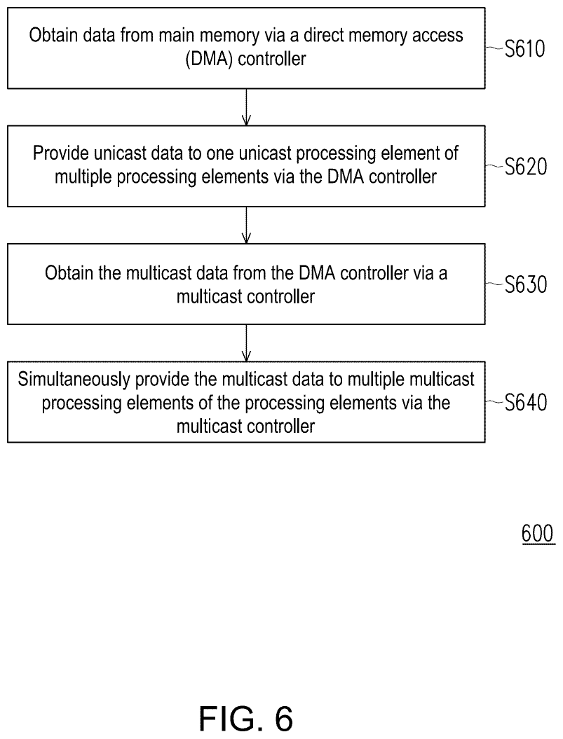

FIG. 6 is a schematic flowchart of a data processing method according to an embodiment of the disclosure. Referring to FIG. 6, a data processing method 600 may include step S610, step S620, step S630, and step S640.

In step S610, the DMA controller 120 may obtain data from the main memory 110, and the data may include unicast data or multicast data. In step S620, the DMA controller 120 may provide the unicast data to one unicast PE of the PEs 140. In step S630, the multicast controller 130 may obtain the multicast data from the DMA controller 120. In step S640, the multicast controller 130 may simultaneously provide the multicast data to multiple multicast PEs of the PEs 140. As a result, the data processing method 600 may achieve low-latency communication between the memory and the multi-core clusters, thereby improving overall computing efficiency and reducing the energy consumption required for data movement.

Moreover, for the implementation details of the data processing method 600, reference may be made to the descriptions of FIG. 1 to FIG. 4C to obtain sufficient teaching, suggestion, and implementation of the embodiment, and the details are not described again here.

In summary, according to the data processing device 100 and the data processing method 600, by adding the multicast controller 130 to the processor architecture, the limitation of conventional architectures that merely support one-to-one single-point transmission may be improved, thereby achieving one-to-many transmission. Therefore, the data processing device 100 and the data processing method 600 may achieve low-latency communication between the memory and the multi-core clusters, thereby improving overall computing efficiency and reducing the energy consumption required for data movement.

For those skilled in the art, changes may be made to the above embodiments without departing from the broad inventive concept of the disclosure. Therefore, it should be understood that the invention disclosed herein is not limited to the specific embodiments disclosed, and is intended to cover modifications within the spirit and scope of the disclosure.

It will be apparent to those skilled in the art that various modifications and variations can be made to the disclosed embodiments. It is intended that the specification and examples be considered as exemplars only, with a true scope of the disclosure being indicated by the following claims and their equivalents

What is claimed is:

1. A data processing device, comprising:
main memory, configured to store data, wherein the data comprises unicast data or multicast data;
a plurality of processing elements, configured to process the data;
a direct memory access (DMA) controller, configured to obtain the data from the main memory, provide the unicast data to one unicast processing element of the plurality of processing elements, and provide the multicast data to a multicast controller; and
the multicast controller, configured to obtain the multicast data from the DMA controller, and simultaneously provide the multicast data to a plurality of multicast processing elements of the plurality of processing elements.

2. The data processing device according to claim 1, further comprising:
a bus, configured to transmit the unicast data, wherein the DMA controller is configured to provide the unicast data to the one unicast processing element via the bus, and the bus is coupled between the DMA controller, the plurality of processing elements, and the main memory.

3. The data processing device according to claim 1, further comprising:
a multicast channel, configured to transmit the multicast data, wherein the multicast controller is configured to simultaneously provide the multicast data to the plurality of multicast processing elements via the multicast channel, and the multicast channel is coupled between the multicast controller and the plurality of processing elements.

4. The data processing device according to claim 1, further comprising:
a mode multiplexer, coupled between the DMA controller and the multicast controller, and configured to, based on a mode signal, transmit the data from the DMA controller to the one unicast processing element or the plurality of multicast processing elements.

5. The data processing device according to claim 1, further comprising:
a central processing unit, configured to:
in response to a transmission object of the data being one of the processing elements, determine the data as the unicast data; and
in response to the transmission object of the data being two or more of the processing elements, determine the data as the multicast data.

6. The data processing device according to claim 1, further comprising:
a central processing unit, configured to:
based on a user command, determine the data as the unicast data or the multicast data.

7. The data processing device according to claim 1, wherein the multicast controller comprises:
a protocol translator, configured to convert the multicast data from a first protocol to a second protocol.

8. The data processing device according to claim 6, wherein the multicast controller comprises:
an activate switching device, configured to, based on a configuration signal, determine at least two processing elements from the plurality of processing elements as the plurality of multicast processing elements.

9. The data processing device according to claim 8, wherein the activate switching device comprises:
a plurality of transport multiplexers, configured to, based on the configuration signal, activate transmission channels coupling the multicast controller to the plurality of multicast processing elements, and deactivate transmission channels coupling the multicast controller to other processing elements of the plurality of processing elements.

10. The data processing device according to claim 9, further comprising:
a configure register, configured to receive and store the configuration signal from the central processing unit, and provide the configuration signal to the plurality of transport multiplexers.

11. A data processing method, comprising:
obtaining data from main memory via a direct memory access (DMA) controller, wherein the data comprises unicast data or multicast data;
providing the unicast data to one unicast processing element of a plurality of processing elements via the DMA controller;
obtaining the multicast data from the DMA controller via a multicast controller; and
simultaneously providing the multicast data to a plurality of multicast processing elements of the plurality of processing elements via the multicast controller.

12. The data processing method according to claim 11, further comprising:
transmitting the unicast data via a bus, wherein the DMA controller is configured to provide the unicast data to the one unicast processing element via the bus, and the bus is coupled between the DMA controller, the plurality of processing elements and the main memory.

13. The data processing method according to claim 11, further comprising:
transmitting the multicast data via a multicast channel, wherein the multicast controller is configured to simultaneously provide the multicast data to the plurality of multicast processing elements via the multicast channel, and the multicast channel is coupled between the multicast controller and the plurality of processing elements.

14. The data processing method according to claim 11, further comprising:
transmitting the data from the DMA controller to the one unicast processing element or the plurality of multicast processing elements based on a mode signal via a mode multiplexer.

15. The data processing method according to claim 11, further comprising:
determining the data as the unicast data via a central processing unit in response to a transmission object of the data being one of the processing elements; and
determining the data as the multicast data via the central processing unit in response to the transmission object of the data being two or more of the processing elements.

16. The data processing method according to claim 11, further comprising:
determining the data as the unicast data or the multicast data based on a user command via a central processing unit.

17. The data processing method according to claim 11, further comprising:
converting the multicast data from a first protocol to a second protocol via a protocol translator.

18. The data processing method according to claim 11, further comprising:
determining at least two processing elements from the plurality of processing elements as the plurality of multicast processing elements based on a configuration signal via an activate switching device.

19. The data processing method according to claim 18, further comprising:
activating transmission channels coupling the multicast controller to the plurality of multicast processing elements, and deactivating transmission channels coupling the multicast controller to other processing elements of the plurality of processing elements, based on the configuration signal via a plurality of transport multiplexers.

20. The data processing method according to claim 19, further comprising:
receiving and storing the configuration signal from a central processing unit, and providing the configuration signal to the plurality of transport multiplexers via a configure register.
